(19) United States
(12) Patent Application Publication
(10) Pub. No.: US 2026/0355958 A1
(43) Pub. Date: Nov. 12, 2026

(54) Autonomous System and Method for Retail Shelf Management

(71) Applicants: Hans Lukas Segelmark, Solna (SE); Davide Peron, Lidingo (SE); Victor Nan Fernandez-Ayala, Stockholm (SE)

(72) Inventors: Hans Lukas Segelmark, Solna (SE); Davide Peron, Lidingo (SE); Victor Nan Fernandez-Ayala, Stockholm (SE)

(21) Appl. No.: 19/199,515

(22) Filed: May 6, 2025

(51) Int. Cl. B25J 9/16; B25J 5/00; B25J 19/02; G06Q 10/087

(52) U.S. Cl. CPC B25J 9/1669; B25J 5/007; B25J 9/162; B25J 9/1666; B25J 9/1676; B25J 9/1682; B25J 19/023; G06Q 10/087

(57) ABSTRACT

A system for autonomous retail shelf management includes a robotic manipulator, a sensor array, a verification module, and a temporary storage area. The system receives shelf configuration and planogram data to generate a shelf mapping. It systematically removes items from retail shelves, verifies each item's identity and expiration information, and organizes verified items in temporary storage based on expiration dates. The system generates a placement plan defining an arrangement of items and directs the robotic manipulator to execute this plan, placing items according to the defined arrangement. This automation addresses traditional shelf management challenges including product verification, stock rotation, and planogram compliance while reducing manual labor requirements. The system integrates multiple capabilities including expiration date management and precise product placement into a single autonomous workflow, improving operational efficiency and product freshness management in retail environments.

### CROSS-REFERENCE TO RELATED APPLICATIONS

This application claims priority to GB Patent Application No. GB 2500332.8, filed on 10 Jan. 2025, the entire contents of which are hereby incorporated by reference.

### FIELD OF INVENTION

The present invention relates to automated robotic systems in retail environments, specifically to systems and methods for autonomous retail shelf management incorporating product verification, expiration date tracking, and correct product arrangement according to planogram specifications.

### BACKGROUND

In the modern retail environment, effective shelf management represents a critical operational challenge that directly impacts customer experience, operational efficiency, and profitability. Traditional approaches to shelf management have predominantly relied on manual labor, requiring store associates to continuously monitor, organize, and maintain product arrangements throughout retail establishments. This process encompasses numerous labor-intensive tasks including product placement, facing, stock rotation, expiration date verification, and planogram compliance verification, all of which consume significant employee time and resources.

The manual nature of conventional shelf management introduces several fundamental limitations that create operational inefficiencies. Store personnel must regularly inspect shelves to identify misplaced items, ensure proper product facing, and verify that products are arranged according to planogram specifications. This process is not only time-consuming but also highly susceptible to human error, particularly during peak shopping hours or in retail environments with extensive SKU diversity. Inventory accuracy challenges represent a critical weakness of manual systems, where discrepancies between recorded and actual stock levels risks resulting in stockouts or overstocking situations impacting sales performance and customer satisfaction. Furthermore, the repetitive and physically demanding nature of shelf stocking work contributes to employee fatigue and turnover. Furthermore, the labor-intensive requirements of manual shelf management contribute substantially to operational costs, with retailers allocating significant portions of their workforce to these repetitive tasks.

Proper stock rotation and expiration date management present additional challenges within current retail operations. Manual verification of product expiration dates is both time-consuming and error-prone, frequently resulting in expired products remaining on shelves or improper rotation where newer items are placed in more accessible positions than older inventory. These inconsistencies can lead to increased product waste, potential regulatory compliance issues, and diminished customer satisfaction when consumers encounter expired or soon-to-expire merchandise. The economic impact of improper stock rotation extends beyond direct waste, affecting inventory accuracy, reordering efficiency, and overall operational productivity.

Existing technological solutions have attempted to address these challenges through various approaches, but significant limitations remain. Current automated systems typically focus on specific, isolated tasks such as inventory scanning or simple pick-and-place operations rather than providing comprehensive shelf management solutions. While some robotic systems can perform basic item movement, they generally lack the sophisticated product handling capabilities required for proper shelf facing and precise alignment according to planogram specifications. Similarly, current solutions employ simplified product identification methods, such as basic barcode scanning or RFID tracking, which prove insufficient in real-world retail environments where products may be partially obscured, damaged, or positioned in ways that prevent reliable identification.

The disconnect between physical shelf operations and inventory management systems represents another significant limitation of current approaches. While some existing solutions can track expiration dates in inventory databases, they lack the capability to physically organize products based on these dates, resulting in continued reliance on manual processes for proper stock rotation. Additionally, most current automation solutions require substantial infrastructure modifications or operational changes to implement, making them impractical or cost-prohibitive for many retail environments. The high cost of implementation combined with limited functionality has resulted in low adoption rates and continued dependence on labor-intensive manual processes across the retail industry. These combined factors create significant operational inefficiencies, increase labor costs, and potentially diminish the customer experience through inconsistent product presentation and availability.

It is within this context that the present invention is provided.

### SUMMARY

The present invention provides a system for autonomous retail shelf management. The system includes a robotic manipulator for removing and placing items on retail shelves, a sensor array for detecting and identifying items, a verification module for analyzing item information, and a temporary storage area for organizing verified items. The system operates under processor control with stored instructions that direct a comprehensive shelf management process. This process encompasses receiving shelf configuration and planogram data, mapping the shelf, systematically removing items, verifying each item, organizing items in temporary storage, generating a placement plan, and executing that plan by placing items on the shelf according to a defined arrangement. The invention reduces labor costs associated with manual shelf management while improving accuracy in product placement, verification, and rotation.

The system integrates multiple capabilities that previously required separate systems or manual intervention. By combining product removal, verification, sorting, and placement into a single automated workflow, the invention provides a comprehensive solution to shelf management challenges. The incorporation of expiration date verification and sorting enables proper stock rotation without manual intervention, reducing product waste. The system's ability to maintain proper product organization according to planogram specifications ensures consistent product presentation across retail locations.

In some embodiments, the sensor array comprises a combination of at least two different sensor types, such as depth cameras, barcode scanners, RFID readers, computer vision cameras, and text recognition sensors. This multi-modal sensing approach provides robust item detection and identification capabilities, allowing the system to operate effectively in varied retail environments with diverse product types.

In further embodiments, the robotic manipulator comprises an articulated arm with a gripper configured to adapt to different product sizes and shapes. This adaptability allows the system to handle a wide range of retail products without requiring product-specific handling equipment, increasing the versatility of the system across different retail departments.

In yet further embodiments, the gripper includes force feedback control for adjusting grip strength based on item characteristics. This feature reduces the risk of product damage during handling by applying appropriate force based on the specific requirements of each item, accommodating both fragile and sturdy products within the same operational workflow.

In some embodiments, the verification module scans barcodes to verify item identity, extracts expiration date information using optical character recognition, and compares this information against a product database. This comprehensive verification process ensures that only correct items with valid expiration dates remain in the active inventory, reducing errors in product placement and improving overall inventory accuracy.

In further embodiments, the temporary storage area organizes items in accordance with a First-In-First-Out (FIFO) principle based on expiration dates. This organization method ensures proper stock rotation by prioritizing earlier-expiring products for placement at the front of shelves, reducing waste from expired products and improving freshness management.

In yet further embodiments, the system identifies items with expired or approaching expiration dates and directs the robotic manipulator to place these items in a designated disposal area. This automated removal of near-expired products reduces the risk of selling expired merchandise and eliminates the need for manual expiration date checking.

In some embodiments, the system identifies items not matching expected product specifications and directs the robotic manipulator to place these items in a designated misplaced item area. This feature reduces planogram compliance errors by automatically removing misplaced or incorrect items from the regular workflow.

In further embodiments, the placement plan generation includes shelf segmentation into zones, determination of zone capacity, assignment of items to zones based on product identity and expiration information, and definition of specific placement coordinates within each zone. This structured approach to placement planning optimizes shelf space utilization while maintaining proper product organization.

In yet further embodiments, the system verifies accurate placement and alignment of each item after placement on the retail shelf. This verification step ensures consistent product presentation and reduces the need for subsequent manual adjustment of product positioning.

In some embodiments, the system includes a mobile platform configured to navigate between multiple retail shelves. This mobility extends the system's operational scope beyond a single shelf location, allowing for comprehensive management across store sections or departments.

In further embodiments, the mobile platform includes a localization and mapping system for autonomous navigation within a retail environment. This capability enables operation without requiring fixed infrastructure or guides, increasing deployment flexibility across different store layouts.

In yet further embodiments, the system updates an inventory management system with current shelf state information after executing the placement plan. This integration with broader store management systems improves inventory accuracy and provides real-time visibility into product availability.

In some embodiments, the system handles multiple stock-keeping units simultaneously during a single shelf management operation. This multi-product capability increases operational efficiency by addressing complete shelf sections rather than processing single product types in isolation.

In further embodiments, the placement plan calculation includes maximizing item visibility while ensuring proper stock rotation. This balanced approach improves both product presentation for customers and operational efficiency for retailers.

In yet further embodiments, the system samples new items to verify consistency and expiration dates before placement, adjusting plans based on verification results. This proactive verification reduces errors from inconsistent or incorrectly supplied inventory.

In some embodiments, the system implements dynamic safety protocols including human presence detection, operation parameter adjustment, and collision avoidance. These safety features allow operation in active retail environments while maintaining safe interaction with store personnel and customers.

In further embodiments, the robotic manipulator includes end-effector mounted cameras providing visual feedback for precise item placement. This close-range visual sensing improves placement accuracy, particularly for small or precisely arranged products.

In yet further embodiments, the system includes a calibration routine aligning coordinate systems between sensors and the robotic manipulator. This calibration ensures accurate translation between detected item positions and robotic movement, improving operational precision.

In some embodiments, the system executes fronting operations placing items at the shelf edge with labels facing forward according to planogram specifications. This fronting capability maintains attractive shelf presentation without requiring separate manual facing processes.

### BRIEF DESCRIPTION OF THE DRAWINGS

Various embodiments of the invention are disclosed in the following detailed description and accompanying drawings.

FIG. 1 illustrates an example system architecture for an autonomous retail shelf management system showing the primary components and their relationships.

FIG. 2 illustrates an example operational workflow for the autonomous retail shelf management system depicting the sequential process steps from initialization through completion.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “first,” “second,” and the like are used to distinguish different elements or features, but these elements or features should not be limited by these terms. A first element or feature described can be referred to as a second element or feature and vice versa without departing from the teachings of the present disclosure.

The term “robotic manipulator” refers to any mechanical device capable of moving, grasping, and manipulating physical objects within a retail environment. This includes, but is not limited to, articulated robotic arms, cartesian coordinate robots, parallel robots, and SCARA robots and may also include a mobile base. In one embodiment the mobile base is an omnidirectional wheeled platform. In one example implementation, the robotic manipulator may be a six-axis articulated arm equipped with an adaptive gripper capable of handling various product sizes and weights commonly found in retail environments, with payload capacity ranging from 0.5 kg to 5 kg to accommodate typical retail products.

The term “sensor array” refers to a collection of one or more sensing devices used to collect data about the retail environment and products. This includes, but is not limited to, RGB cameras, depth cameras, barcode scanners, RFID readers, infrared sensors, and laser range finders. In one example implementation, the sensor array may comprise a primary RGB-D camera mounted on the robotic manipulator for close-range scanning, supplemented by fixed-position cameras providing broader environmental context, with resolutions ranging from 720p to 4K and beyond depending on the required detail level for product identification.

The term “verification module” refers to hardware and/or software components that analyze data to confirm product identity, condition, and relevant attributes. This includes, but is not limited to, barcode reading systems, computer vision algorithms, optical character recognition systems, and database comparison tools. In one example implementation, the verification module may include a barcode scanner with 1D and 2D code capability, combined with Optical Character Recognition (OCR) software capable of reading expiration dates in various formats and positions on packaging.

The term “temporary storage area” refers to any physical space or container within the system used to temporarily hold products during the shelf management process. This includes, but is not limited to, internal shelves, bins, conveyors, or designated areas within the system's operational space. In one example implementation, the temporary storage area may consist of a multi-tiered arrangement of bins with adjustable dividers, allowing for organization of products by category and expiration date, with capacity for up to 50 standard-sized retail items.

The term “shelf configuration data” refers to information describing the physical characteristics and constraints of retail shelves. This includes, but is not limited to, shelf dimensions, load-bearing capacity, shelf spacing, and physical features such as dividers or display elements. In one example implementation, shelf configuration data may include precise measurements of shelf width, depth, and height, along with maximum weight capacity and the presence of any permanent dividers or price tag rails.

The term “planogram data” refers to information specifying the intended arrangement and presentation of products on retail shelves. This includes, but is not limited to, product placement positions, facing requirements, promotional arrangements, and category organization. In one example implementation, planogram data may be provided in standard retail industry formats (such as XML or JSON files) specifying product SKUs, their exact x-y-z coordinates on shelves, orientation requirements, and minimum/maximum facing counts.

The term “shelf mapping” refers to a digital representation of the current state of a retail shelf, including product positions and available space. This includes, but is not limited to, 2D and 3D spatial maps, product location data, and shelf occupancy information. In one example implementation, shelf mapping may be represented as a 3D point cloud with superimposed product identification markers, updated in real-time during operations with position accuracy of ±5 mm to ensure precise manipulation.

The term “placement plan” refers to a structured sequence of steps for arranging products on retail shelves. This includes, but is not limited to, product positioning coordinates, orientation specifications, placement order, and fronting requirements. In one example implementation, the placement plan may be generated as a directed graph where nodes represent specific product placement operations and edges represent the optimal sequence, with each node containing precise x-y-z coordinates and orientation angles.

### DESCRIPTION OF DRAWINGS

The present invention provides a comprehensive system and method for autonomous retail shelf management that addresses the fundamental limitations of manual shelf operations and existing partial automation solutions. As discussed in the background section, conventional shelf management approaches rely heavily on manual labor, leading to operational inefficiencies, inconsistent product presentation, and challenges in maintaining proper stock rotation. The invention described herein represents a significant advancement by integrating multiple shelf management functions—including product removal, verification, organization, and placement—into a single automated system.

At its core, the invention comprises a robotic system capable of autonomously managing retail shelves through a coordinated sequence of operations. By combining advanced robotics, multi-modal sensing, and intelligent planning algorithms, the system eliminates the need for repetitive manual shelf management tasks while improving consistency, accuracy, and efficiency. Unlike existing solutions that address only isolated aspects of shelf management, this invention provides a complete end-to-end solution that maintains shelf organization, ensures proper product rotation, and upholds planogram compliance without human intervention.

The system's integrated approach to shelf management delivers several significant advantages over conventional methods. By automating expiration date verification and implementing date-based product organization, the system substantially reduces the risk of expired products remaining on shelves while ensuring optimal stock rotation. The precision afforded by robotic manipulation and real-time sensing enables consistent product facing and alignment, maintaining visual appeal and brand presentation standards across retail locations. Furthermore, the system's ability to integrate with existing inventory management systems provides real-time visibility into shelf conditions, improving inventory accuracy and operational planning.

The invention's flexible architecture allows for adaptation to various retail environments and product types without requiring extensive infrastructure modifications. Through its modular design and intelligent control systems, the system can accommodate different shelf configurations, product characteristics, and operational requirements. This adaptability makes the invention suitable for implementation across diverse retail sectors, from grocery and pharmacy to general merchandise and specialty retail.

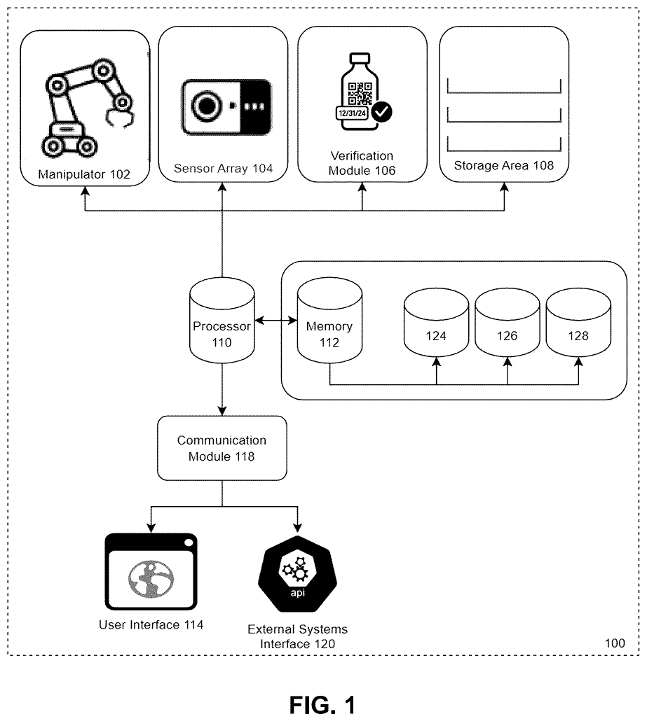

Referring now to FIG. 1, there is shown a block diagram illustrating the system architecture of an autonomous retail shelf management system 100 according to an embodiment of the present invention. The system 100 may be implemented as a unified structure or with components distributed across multiple physical units or housed within a single integrated platform.

The system 100 includes a robotic manipulator 102 configured to remove items from and place items onto retail shelves. The robotic manipulator 102 may be implemented as an articulated arm with multiple degrees of freedom, a cartesian coordinate robot, a SCARA robot, or other suitable robotic mechanisms. The robotic manipulator 102 may include an adaptive gripper capable of handling various product sizes and shapes, with capabilities for adjusting grip force based on product characteristics. In some implementations, the robotic manipulator 102 may feature end-effector mounted cameras providing visual feedback for precise placement operations.

Connected to the robotic manipulator 102 is a sensor array 104 comprising at least one sensor configured to detect and identify items on retail shelves. The sensor array 104 may include various types of sensors such as RGB cameras, depth cameras, barcode scanners, RFID readers, infrared sensors, and laser range finders. These sensors may be mounted on the robotic manipulator 102, positioned at fixed locations relative to the operational area, or distributed in a combination of both arrangements. The sensor array 104 provides data used for shelf mapping, product detection, and verification processes.

The system 100 further includes a verification module 106 configured to analyze each item removed from retail shelves to determine item identity, expiration information, and placement validity. The verification module 106 may incorporate barcode reading capabilities, optical character recognition for expiration date extraction, computer vision algorithms for product recognition, and database comparison functionality. The verification module 106 may be implemented as hardware components, software algorithms, or a combination thereof.

A temporary storage area 108 is included in the system 100, configured to organize verified items according to at least one organizing principle, such as expiration date or product category. The temporary storage area 108 may be implemented as physical compartments, bins, shelves, or other suitable storage mechanisms within the system's operational space. In some implementations, the temporary storage area 108 may include specific sections for different expiration date ranges and product categories, with capacity sensors and status indicators providing real-time information about storage utilization.

The system 100 includes a processor 110 providing computational capabilities for the system, executing algorithms for shelf mapping, product verification, placement planning, and robotic control. The processor 110 may be implemented using general-purpose microprocessors, application-specific integrated circuits (ASICs), field-programmable gate arrays (FPGAs), or other suitable processing technologies. In some implementations, distributed processing architectures may be employed with specialized processors handling different aspects of the system's operation.

Connected to the processor 110 is memory 112 storing instructions and data used by the processor 110, including operating algorithms, configuration parameters, product information, and operational logs. The memory 112 may include various types of storage media such as random-access memory (RAM), read-only memory (ROM), solid-state drives, magnetic storage, or other suitable storage technologies. In some implementations, the memory 112 may be distributed across multiple storage devices or include hierarchical storage arrangements for different types of data.

The memory has access to several data resources which may be external or stored, including a shelf configuration database 124, a planogram database 126, and a product information database 128. These databases provide essential reference information for the system's operation. The shelf configuration database 124 contains information about shelf dimensions, weight capacities, and physical features. The planogram database 126 stores intended product placement specifications defined by retail planning. The product information database 128 maintains details about product characteristics, identifiers, and requirements. While shown as separate databases, this information may be integrated within a unified retail management system in some implementations.

The system 100 also includes a user interface 114 providing mechanisms for operator interaction with the system, including system configuration, operation monitoring, and manual intervention when necessary. The user interface 114 may be implemented as a touchscreen display, physical control panel, remote access application, or combination of interface technologies. In some implementations, the user interface 114 may provide visualization of shelf states, operation progress, and system diagnostics.

As part of the robotic manipulator the may be a mobile platform providing mobility to the system 100, allowing it to navigate between different shelf locations within a retail environment. The mobile platform may be implemented as a wheeled base, tracked vehicle, or other suitable locomotion mechanism. In some implementations, the mobile platform may include localization and mapping capabilities for autonomous navigation through retail spaces without requiring fixed infrastructure.

The system 100 includes a communication module 118 enabling data exchange between the system and external networks or systems, facilitating integration with broader retail management infrastructure. The communication module 118 may implement wired connections, wireless protocols, or a combination of connectivity technologies suitable for the operational environment.

An external systems interface 120 is included in the system 100 providing specific integration points with other retail systems such as inventory management, order processing, and analytics platforms. The external systems interface 120 may implement standardized protocols and data formats to ensure compatibility with various retail management systems.

Data flow connections connect the various components of the system 100. These connections represent the paths of information exchange between system elements, enabling coordinated operation across the entire system. These connections may be implemented through internal data buses, network connections, or other suitable communication channels depending on the specific system architecture.

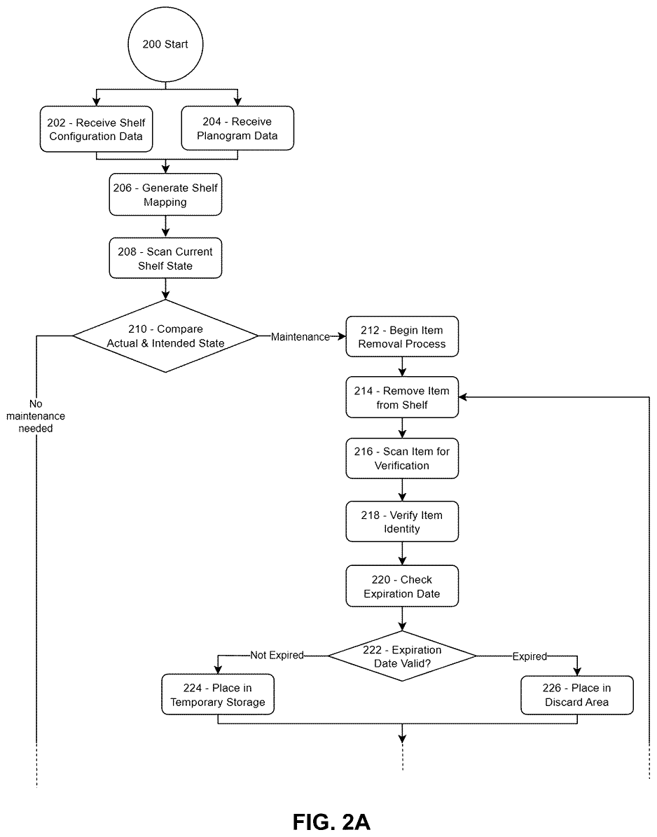

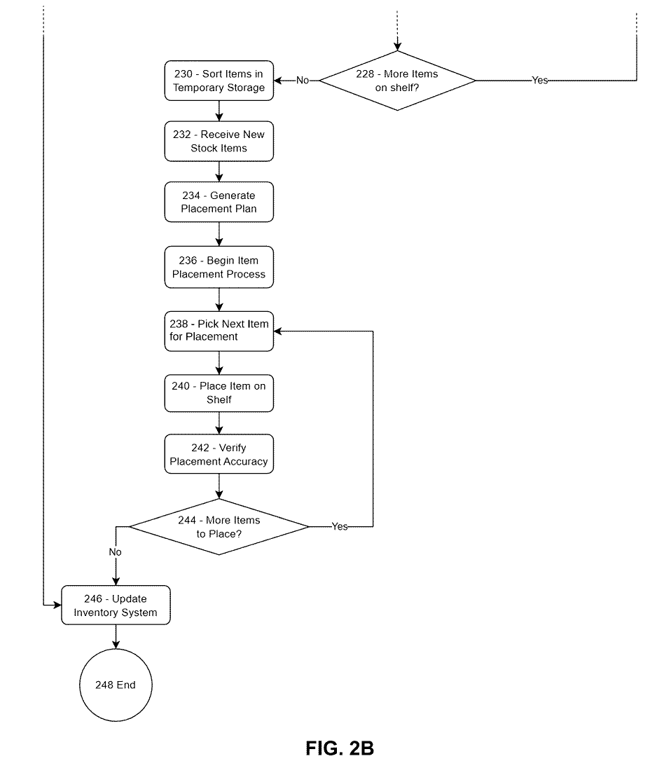

Referring now to FIGS. 2A and 2B, there is shown a flowchart (split across the two figures) illustrating the operational workflow of the autonomous retail shelf management system according to an embodiment of the present invention.

In FIG. 2A, the workflow begins with a start operation 200 which may be triggered by various events including scheduled maintenance times, inventory discrepancy detection, or manual initiation through the user interface.

Following initiation, the system receives shelf configuration data at step 202. This shelf configuration data includes information about the physical characteristics of the target retail shelf such as dimensions, load-bearing capacity, shelf spacing, and physical features. The shelf configuration data may be retrieved from the shelf configuration database or measured in real-time using the sensor array. In some implementations, the system may incorporate shelf identification markers to automatically identify specific shelf units and retrieve their associated configuration data.

The system may also or alternatively receive planogram data at step 204. This planogram data defines the intended product placement specifications for the retail shelf, including product locations, facing requirements, and category organization. The planogram data may be provided in various industry-standard formats and may include specific rules for product arrangement such as brand grouping, promotional positioning, or seasonal display requirements. In some implementations, the planogram data may include priority indicators for certain products or sections requiring more frequent attention.

At step 206, the system generates a shelf mapping based on the received data. This shelf mapping creates a digital representation of the intended shelf state, incorporating both physical constraints from the configuration data and product arrangement specifications from the planogram data. The shelf mapping may be represented in various formats including two-dimensional schematics, three-dimensional spatial models, or abstract data structures optimized for computational efficiency.

The system then scans the current shelf state at step 208 using the sensor array. This scanning process captures the actual condition of the retail shelf, identifying product positions, orientations, and available space. The scanning may employ various sensing technologies including computer vision, depth sensing, and barcode reading to create a comprehensive representation of the current shelf state. In some implementations, multiple scanning passes may be performed from different angles to ensure complete coverage and minimize occlusion issues.

At step 210, the system compares the actual shelf state against the intended state derived from the planogram data. This comparison identifies discrepancies such as missing products, misplaced items, improper facings, or other deviations from the intended arrangement. Based on this comparison, the system determines whether shelf maintenance is required and what specific actions should be taken. If no significant discrepancies are detected, the system may proceed directly to step 246 to update the inventory system and conclude the operation.

When maintenance is required, the system begins the item removal process at step 212. This step initializes the systematic approach to shelf reorganization, preparing the robotic manipulator and associated systems for the removal phase. This preparation may include positioning the robotic manipulator at an optimal starting location, initializing the verification module, and preparing the temporary storage area for incoming items.

At step 214, the system removes an item from the shelf using the robotic manipulator. The robotic manipulator approaches the item using a motion plan that avoids collisions with other shelf contents and structures. The manipulator then grasps the item using appropriate techniques for the specific product characteristics. In some implementations, the system may employ different gripping strategies based on product size, weight, fragility, or packaging type. The removal sequence may follow an optimized path to minimize operation time and manipulator movement.

After removal, the system scans the item for verification at step 216. This scanning employs the verification module to collect identifying information from the item, which may include barcode scanning, image-based recognition, or RFID reading. The scanning process may capture multiple views or angles of the product to ensure reliable data collection even when primary identifiers are obscured or damaged.

At step 218, the system verifies the item identity by comparing the collected information against product database records. This verification determines whether the item matches an expected product for the shelf location. If the identity cannot be verified or the item is identified as a misplaced product, the system may direct the item to a designated area for misplaced items or manual intervention.

For verified items, the system proceeds to check the expiration date at step 220. This check may involve optical character recognition of printed date codes, reading of encoded date information, or database lookups based on lot numbers or other identifiers. The expiration date checking may employ various algorithms to handle different date formats, languages, or printing variations commonly found in retail environments.

At step 222, the system evaluates whether the expiration date is valid according to predetermined criteria. These criteria may include absolute expiration thresholds, relative freshness requirements, or store-specific policies for minimum remaining shelf life. If the expiration date is valid, the system proceeds to step 224; otherwise, it directs the item to step 226.

Valid items are placed in the temporary storage area at step 224. Within this storage area, items may be organized according to various principles including expiration date sequence, product category, or planned placement order. The temporary storage area maintains items in an ordered state to facilitate efficient retrieval during the subsequent placement phase. In some implementations, the storage area may include multiple zones or compartments optimized for different product types or handling priorities.

Items with invalid expiration dates are placed in a discard area at step 226. This area may be further subdivided based on disposition requirements such as returns to vendors, donations, or disposal. The system may record information about discarded items for inventory reconciliation and waste tracking purposes.

In FIG. 2B, at step 228, the system determines whether more items remain on the shelf requiring removal and processing. If additional items require processing, the system returns to step 214 to continue the removal cycle. This iterative process continues until all targeted shelf items have been processed. In some implementations, the system may prioritize certain shelf sections or product categories based on business rules or operational efficiency considerations.

After completing the removal phase, the system sorts items in the temporary storage area at step 230. This sorting organizes items according to the placement strategy, typically prioritizing earliest expiration dates for first placement to ensure proper stock rotation. The sorting process may employ various algorithms to optimize the subsequent placement sequence based on multiple factors including expiration dates, physical item characteristics, and planogram requirements.

At step 232, the system receives new stock items if applicable. These new items may be supplied through manual loading into a designated input area or through integration with automated supply systems. New stock items may undergo sampling verification to confirm product identity, check expiration dates, and validate product condition before integration into the placement plan. In some implementations, the system may adjust the placement plan based on the characteristics of the new stock to optimize freshness management and planogram compliance.

The system generates a placement plan at step 234 based on the verified items in temporary storage, new stock items, and planogram requirements. This placement plan defines the specific arrangement of products on the shelf, including precise positioning coordinates, orientation specifications, and placement sequence. The plan optimizes various factors including product visibility, accessibility, stock rotation, and planogram compliance. In some implementations, the plan may incorporate dynamic adjustments based on real-time feedback during the placement process.

At step 236, the system begins the item placement process, initializing the necessary systems and positioning the robotic manipulator for efficient operation. This initialization may include calibration routines to ensure precise coordination between the manipulator and the shelf coordinates.

The system picks the next item for placement at step 238 according to the placement plan sequence. This selection typically follows the optimized order determined during plan generation, with consideration for proper stock rotation and planogram requirements. In some implementations, the selection algorithm may incorporate real-time adjustments based on operational conditions or placement feedback.

At step 240, the system places the selected item on the shelf using the robotic manipulator. The placement operation includes precise positioning at the coordinates specified in the placement plan, with appropriate orientation to ensure product facing and alignment. The placement may employ various techniques including gentle setting, sliding insertion, or stacking depending on product characteristics and shelf configuration. In some implementations, the system may use visual servoing or force feedback to fine-tune the placement accuracy.

After placement, the system verifies placement accuracy at step 242 using the sensor array. This verification confirms that the item is correctly positioned, properly oriented, and stably situated on the shelf. If the placement does not meet accuracy requirements, the system may attempt repositioning or, in cases of persistent issues, direct the item to a designated area for manual handling.

At step 244, the system determines whether more items remain to be placed according to the placement plan. If additional items require placement, the system returns to step 238 to continue the placement cycle. This iterative process continues until all planned items have been placed or until physical shelf capacity is reached.

After completing the placement phase, the system updates the inventory management system at step 246 with the current shelf state information. This update may include detailed product counts, placement confirmations, expiration date distributions, and discrepancy reports. In some implementations, the system may also generate analytics regarding shelf utilization, product movement patterns, or planogram compliance metrics.

The workflow concludes with an end operation 248, which finalizes the shelf management process. This conclusion may include system repositioning, resource release, operational logging, and preparation for subsequent operations. In continuous operation scenarios, the system may immediately begin processing the next scheduled shelf or enter a standby state awaiting the next triggered operation.

### Shelf Mapping Process

The autonomous retail shelf management system employs sophisticated space interpretation and product arrangement planning methodologies. A typical retail shelf unit in this system consists of multiple vertically arranged shelf levels. These shelf units can be constructed from various materials including metal, wood, plastic, or composite materials that meet retail environment requirements. The system may incorporate additional functionality such as adjustable height mechanisms, integrated lighting, or electronic shelf labels.

The standard configuration includes three distinct shelf levels, though the system adapts to varying numbers of levels based on specific retail requirements. Each shelf level provides a horizontal surface for product placement and attaches to the shelf unit structure through brackets, slots, or other mounting mechanisms. The vertical spacing between shelf levels can be uniform or variable depending on the product categories being displayed.

Each shelf level is organizationally subdivided into distinct zones that define boundaries for product categories. These zones correspond to different product families, brands, or merchandising groups. Zone divisions typically function as logical separations rather than physical dividers, though some implementations may incorporate physical zone dividers for certain product categories.

Various product types are positioned on the shelf levels according to planogram specifications that define optimal product positioning for merchandising effectiveness and operational efficiency. The system accounts for actual product dimensions in relation to shelf proportions to maximize space utilization.

The system utilizes a precise coordinate reference system for product positioning during automated placement operations. This coordinate system typically designates the front left corner of each shelf level as the origin point, with x-coordinates increasing from left to right and y-coordinates increasing from front to back. In some implementations, z-coordinates are also incorporated to account for vertical positioning within the available shelf height. These coordinates enable the robotic manipulator to achieve millimeter-level precision in product placement.

Shelf dimensions, including width, depth, and height measurements, are critical parameters that define the available space for product placement. Precise dimensional data enables accurate space allocation and product placement planning. In some implementations, these dimensions are obtained through direct measurement by the system's sensors or retrieved from stored configuration data.

The system follows planogram specifications that detail intended product placements according to retail merchandising plans. These planograms serve as reference patterns that the system aims to match during product placement operations. Planogram specifications include requirements for product positioning, orientation, and facing counts. Advanced implementations may incorporate additional metadata such as promotional flags, priority indicators, or special handling instructions.

The system continuously monitors available space within shelf levels, identifying locations without current product placement. These spaces may represent opportunities for additional product placement or intentional spacing required by the planogram. Monitoring available space optimizes product arrangement and identifies restocking needs. Certain implementations enforce minimum spacing requirements between product types based on merchandising guidelines or product characteristics.

Product presentation is prioritized through precise alignment with the front edge of each shelf level. This practice, known as “fronting” in retail operations, maintains visually appealing and accessible product presentation. Enhanced implementations may incorporate front edge features such as product stops, pricing rails, or other merchandising elements.

Product facing direction is managed by the system to ensure that product labels and branding remain visible to customers. Consistent facing direction is maintained during product placement operations according to planogram specifications. Some implementations vary facing requirements by product type or shelf position based on specific merchandising strategies.

The system employs sensing technology to detect and identify products, verify placement accuracy, and monitor shelf conditions. Multiple overlapping sensor fields ensure complete coverage of the shelf area. Advanced implementations dynamically adjust sensor positioning to optimize detection capabilities for different shelf configurations or product types.

Product identification is facilitated through machine-readable identifiers such as barcodes, QR codes, RFID tags, or other identification technologies. These identifiers are essential during both removal and placement operations to ensure correct product handling. Some implementations supplement tag-based identification with computer vision techniques that identify products based on packaging characteristics when tags are not visible or readable.

The system calculates capacity indicators as numerical values within zones, representing the maximum number of product units accommodatable in each zone. These calculations consider product dimensions, shelf dimensions, and spacing requirements. Capacity data guides placement planning to optimize space utilization while maintaining planogram compliance. Advanced implementations dynamically adjust capacity indicators based on actual product dimensions measured during handling operations.

Vertical clearance between shelf levels is a critical measurement that ensures sufficient space for product placement. This clearance must accommodate the tallest products intended for each shelf level while allowing safe and efficient handling by the robotic manipulator. In adjustable shelf systems, vertical clearance can be reconfigured based on changing product assortments or seasonal merchandising requirements. Some implementations include recommendation functionality for optimal shelf spacing configurations to maximize display capacity while maintaining proper product presentation.

### Product Sorting Process

The autonomous retail shelf management system incorporates a temporary storage component with a structured organization methodology designed for efficient product management during shelf operations. This storage component serves as an intermediate holding area for products, organized and prioritized based on expiration dates and product categories to facilitate proper stock rotation and planogram compliance during shelf restocking operations.

The temporary storage component comprises several distinct functional areas, each with a specific purpose within the overall workflow. The primary sorting area occupies the largest portion and functions as the main organizational space where most removed and verified products are held during processing. This area may be implemented with various physical configurations including tiered shelves, sliding compartments, or matrix-style bins based on retail environment requirements and product types.

The priority placement section occupies the front portion of the storage component and contains products scheduled for immediate placement onto retail shelves. This section is strategically positioned for optimal accessibility by the robotic manipulator, minimizing movement distance and time during placement operations. Products are arranged in placement sequence order according to optimization algorithms that consider expiration dates, planogram requirements, and operational efficiency.

Behind the priority placement section lies the secondary sorting area, containing products that have been verified and sorted but are not yet scheduled for immediate placement. This area functions as an intermediate holding zone where products await transfer to the priority placement section as space becomes available. This tiered approach enables processing of larger product quantities than could be immediately arranged in placement sequence.

The overflow storage section occupies the rear portion of the storage component, providing additional capacity when primary and secondary sorting areas reach capacity limits. This section proves valuable during high-volume operations or when processing multiple shelf sections simultaneously. Products in the overflow storage section typically follow simplified organizational schemes focused on basic categorization rather than precise placement sequencing.

The organizational structure follows a hierarchical scheme based primarily on expiration dates. The first expiration date zone contains products with the nearest expiration dates, receiving placement priority according to proper stock rotation principles. The second expiration date zone contains products with intermediate expiration dates, while the third expiration date zone contains products with the furthest expiration dates. This expiration-based zoning ensures that older inventory is placed at the front of shelves for earlier consumer selection, reducing expired product waste.

Within each expiration date zone, product category dividers create separate compartments for different product types. These dividers may be fixed or adjustable depending on implementation requirements and constructed from various materials including plastic, metal, or composite materials. The dividers ensure product type separation during sorting and placement, preventing mixing that could compromise planogram compliance.

The categorized compartments contain specific storage locations for individual stock-keeping units (SKUs). Each SKU has a designated storage location within its product category. These locations may be sized according to typical product dimensions and expected quantities. Some implementations include specialized fixtures or contours to accommodate specific product shapes or packaging types.

Flow direction patterns throughout the storage component illustrate product movement through the temporary storage system. These patterns represent the logical progression from initial entry through sorting and organization to eventual exit for shelf placement. Physical implementations may incorporate design features such as sloped surfaces, guide rails, or conveyor mechanisms to facilitate efficient product movement.

Products enter the temporary storage component through an input transfer point that serves as the receiving area for items removed from retail shelves or supplied as new stock. This input area may include initial scanning capabilities to begin verification and sorting as products enter the system. Some implementations incorporate buffer space to accommodate varying inflow rates during removal operations.

Products exit the temporary storage component through an output transfer point that functions as the transition area between storage and placement operations. This output area is positioned for optimal robotic manipulator access and may include final verification scanning to confirm product identity before placement. Some implementations incorporate orientation features ensuring products are presented to the robotic manipulator in optimal grasping positions.

Throughout the storage component, capacity sensors monitor occupancy levels in different storage compartments. These sensors may employ various technologies including optical detection, weight sensing, or proximity detection to track space utilization. Sensor data informs storage management algorithms, allowing dynamic adjustment of sorting strategies based on available space. Some implementations utilize these sensors for inventory tracking and reconciliation.

Status indicators throughout the storage component provide information regarding the operational state of different storage sections. These indicators may display compartment fullness, product priority, or processing status. In implementations with human interaction capabilities, these indicators may guide manual loading or intervention activities. Various signaling methods may be employed including LED lights, digital displays, or color-coded markers depending on system design.

Date label positions within the storage system indicate where expiration information is displayed or recorded. These positions may feature physical label holders, digital displays, or database reference points depending on implementation approach. This ensures expiration information remains associated with products throughout storage and placement, facilitating proper rotation and freshness management. Some implementations include scanning or reading capabilities to update expiration tracking as products move through the system.

A designated discard routing pathway directs products that fail verification or expiration checks to specialized handling areas. This pathway may be implemented as a physical chute, conveyor, or designated transfer route. Advanced implementations include branching pathways to different destinations based on specific removal reasons.

The misplaced item area functions as a collection point for products found in incorrect shelf locations or not matching planogram specifications. Items in this area may require manual verification or special handling to determine proper disposition. This area may include subdivisions based on probable correct locations or product categories. Some implementations interface with inventory reconciliation systems to update stock records based on discovered misplacements.

The expired item area functions as a collection point for products identified as expired or too near expiration date thresholds for continued sale. This area may include subdivisions based on vendor return policies, donation eligibility, or disposal requirements. The area may incorporate scanning or recording capabilities to document removed products for inventory adjustment and waste tracking. Some implementations interface with waste management or vendor return processing systems to streamline subsequent handling.

### Product Verification Processes

The autonomous retail shelf management system incorporates a comprehensive product verification workflow designed to determine product identity, expiration status, and physical condition with high accuracy. This verification process ensures that only suitable products return to retail shelves while expired, damaged, or misplaced items are properly identified and routed for appropriate handling.

The verification process begins at a product input point where items enter the system after shelf removal or as new stock. This input area functions as a physical transfer point designed to accommodate various product dimensions and may include initial sensing capabilities to detect product presence and initiate verification procedures.

Following input, products undergo position stabilization to secure each item in an optimal orientation for verification. This stabilization utilizes mechanisms such as adjustable fixtures, contoured platforms, or robotic manipulation to position product identification features for maximum sensor visibility. Advanced implementations feature dynamic adjustment capabilities based on detected product characteristics or category-specific handling profiles.

The stabilized product undergoes multi-angle imaging that captures visual data from multiple perspectives. This imaging system provides comprehensive visual coverage of the product, ensuring identification features are captured regardless of packaging location. Various imaging technologies may be employed including standard RGB imaging, high-resolution macro photography, or specialized lighting techniques. Enhanced systems incorporate depth sensing for three-dimensional product characterization.

Barcode scanning technology directs scanning beams at the product to detect standard retail identification codes including UPC, EAN, QR codes, and other symbologies. This scanning component may employ various technologies including laser, imager, or camera-based approaches based on system requirements and product characteristics. Multiple scanning devices may operate simultaneously to maximize successful code detection from various angles or packaging surfaces.

The system processes scanning data through a barcode detection algorithm that identifies and decodes product barcodes. This processing incorporates signal enhancement algorithms, partial code reconstruction capabilities, and validation routines for code integrity. The detection process handles multiple barcode symbologies common in retail environments through specialized decoding technologies.

A decision point evaluates whether valid barcode identification has occurred. Upon successful barcode detection, the process advances to database verification. When barcode identification fails, the system activates alternative identification methods.

Alternative identification utilizes computer vision and pattern recognition to identify products based on packaging characteristics, logos, shapes, colors, and other visual attributes. This approach leverages machine learning algorithms trained on product image databases to identify items when standard codes are inaccessible. Enhanced implementations incorporate supplementary sensing including weight measurement, dimensional analysis, or spectral characterization.

The product database verification compares identification data against a comprehensive product database to retrieve specifications, attributes, planogram information, and verification parameters. This database may reside locally or connect to central retail management systems. Advanced implementations include fuzzy matching capabilities for handling partial or uncertain identification information.

Another decision point determines whether the product matches a known inventory item. Successfully identified products proceed to expiration verification. Products that remain unidentified despite multiple identification attempts are marked as unknown items.

Unknown items receive special designation for manual handling or intervention outside the automated workflow. These items typically route to designated inspection areas for human processing. Some implementations record detailed sensing data from unknown items to facilitate future identification or inventory reconciliation.

For identified products, expiration date detection analyzes packaging to locate date information. This process employs pattern recognition to identify common date formats and layouts across product categories. Product-specific templates may guide the search for date codes in typical positions. Enhanced systems utilize multiple approaches including direct visual inspection, specialized illumination, or category-based search patterns.

Optical character recognition processes the targeted regions to extract date information from packaging. Specialized OCR algorithms optimized for varied fonts, printing styles, and retail date formats convert visual data to machine-readable text. Pre-processing routines enhance image quality and compensate for packaging curvature or printing variations. Advanced implementations may employ multiple parallel OCR methods with result comparison for reliability enhancement.

The system evaluates whether usable date information has been extracted from the product. Successfully extracted date information advances to validation processing. Failed extraction may trigger additional verification procedures or product-specific handling based on implementation requirements.

Date validation processing interprets extracted information according to various formats and standards. The validation algorithms identify date patterns, differentiate between production and expiration dates, and standardize format representation for comparison. Contextual analysis resolves formatting ambiguities such as international date format variations. Advanced implementations incorporate product-specific rules for shelf life calculation or regional dating requirements.

The system determines whether the expiration date satisfies predetermined freshness criteria. These criteria may include absolute expiration thresholds, minimum remaining shelf life requirements, or category-specific standards. Products with valid dates proceed to condition assessment. Products with invalid dates, indicating expiration or insufficient remaining shelf life, are classified as invalid.

Product condition assessment evaluates physical characteristics to identify damage, tampering, or other issues affecting salability. This assessment uses visual inspection for package integrity, deformation, leakage, or other visible damage indicators. Multiple sensing technologies may contribute including computer vision, weight verification, or structural analysis. Specialized implementations may include product-specific testing such as seal integrity verification or container pressure testing.

The system evaluates whether the product's physical condition meets quality standards. Products in acceptable condition receive valid classification. Products with unacceptable conditions due to damage or other issues receive invalid classification.

Valid products that pass all verification steps are designated for return to retail shelves or inclusion in restocking operations. These products may receive priority coding or handling instructions based on verification results such as expiration proximity or placement requirements. Advanced implementations may assign additional metadata including freshness ratings or quality assessments that influence placement decisions.

Invalid products that fail verification criteria receive designation preventing return to retail shelves. This classification may include reason codes specifying failure type such as expiration, damage, or identification issues. These codes influence subsequent routing and handling decisions. Some implementations apply graduated invalid classifications based on failure type for nuanced handling of different product conditions.

Valid products route to temporary storage where they organize according to expiration dates and product categories. This routing may utilize robotic manipulation, conveyor systems, or gravity-assisted delivery based on system design. Advanced implementations include specific placement instructions based on verification results and intended handling procedures.

Invalid products route to designated discard areas for appropriate processing based on invalidation reasons. This routing may direct expired products to vendor return areas, damaged products to waste processing, or unidentified products to inspection stations. Various transfer technologies facilitate this routing with potential segregation capabilities for different invalid product types based on handling requirements.

Throughout verification, comprehensive data recording captures information about each product and its verification results. This recording includes identification details, expiration information, condition assessments, and disposition decisions to support inventory reconciliation, waste tracking, and performance monitoring. Enhanced implementations include image archiving for reference or audit purposes, particularly for products requiring special handling.

The verification process concludes with cycle completion, triggering subsequent system actions such as initiating new verification cycles, updating inventory records, or advancing to placement planning. In continuous operation, verification completion immediately activates product input for the next processing item.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A system for autonomous retail shelf management, comprising:
a robotic manipulator configured to remove items from and place items onto a retail shelf;
a sensor array comprising at least one sensor configured to detect and identify items on the retail shelf;
a verification module configured to analyze each item removed from the retail shelf to determine item identity, expiration information, and placement validity;
a processor; and
a memory storing instructions that, when executed by the processor, cause the system to:
receive shelf configuration data comprising shelf dimensions and product placement constraints and/or receive planogram data defining intended product placement specifications for the retail shelf;
generate a shelf mapping based on data from the sensor array and/or the planogram data;
direct the robotic manipulator to systematically remove items from the retail shelf;
process each removed item through the verification module;
sort verified items within a temporary storage area based on at least the expiration information;
generate a placement plan that defines an arrangement of items to be placed on the retail shelf based on at least the shelf configuration data, the planogram data, and results from the verification module; and
direct the robotic manipulator to execute the placement plan by placing items on the retail shelf according to the defined arrangement.

2. The system of claim 1, wherein the sensor array comprises a combination of at least two of: a depth camera, a barcode scanner, an RFID reader, a computer vision camera, and a text recognition sensor.

3. The system of claim 1, wherein the robotic manipulator comprises an articulated arm with a gripper configured to adapt to different product sizes and shapes.

4. The system of claim 3, wherein the robotic manipulator includes one or more product manipulation mechanisms selected from the group consisting of: force-feedback grippers, vacuum grippers, suction devices, and magnetic lifting tools.

5. The system of claim 1, wherein the verification module is configured to:
scan a barcode on each item to verify item identity;
extract expiration date information using optical character recognition; and
compare extracted information against a product database.

6. The system of claim 1, wherein the temporary storage area is configured to organize items in accordance with a First-In-First-Out (FIFO) principle based on expiration dates.

7. The system of claim 1, wherein the instructions further cause the system to:
identify items with expired or approaching expiration dates; and
direct the robotic manipulator to place identified items in a designated disposal area.

8. The system of claim 1, wherein the instructions further cause the system to:
identify items not matching expected product specifications; and
direct the robotic manipulator to place identified items in a designated misplaced item area.

9. The system of claim 1, wherein generating the placement plan comprises:
segmenting the retail shelf into zones;
determining item capacity for each zone;
assigning items to zones based on product identity and expiration information; and
defining specific placement coordinates for each item within its assigned zone.

10. The system of claim 1, wherein the instructions further cause the system to verify accurate placement and alignment of each item after placement on the retail shelf.

11. The system of claim 1, wherein the system further comprises a mobile platform configured to navigate between multiple retail shelves.

12. The system of claim 11, wherein the mobile platform includes a localization and mapping system for autonomous navigation within a retail environment.

13. The system of claim 1, wherein the instructions further cause the system to update an inventory management system with current shelf state information after executing the placement plan.

14. The system of claim 1, wherein the instructions further cause the system to handle multiple stock-keeping units (SKUs) simultaneously during a single shelf management operation.

15. The system of claim 1, wherein generating the placement plan further comprises calculating a facing arrangement that maximizes visibility of items while ensuring proper stock rotation.

16. The system of claim 1, wherein the instructions further cause the system to:
sample a subset of new items to be placed on the retail shelf;
verify SKU consistency and expiration dates of the sampled subset; and
adjust the placement plan based on the verification results.

17. The system of claim 1, wherein the instructions further cause the system to implement dynamic safety protocols including:
detecting human presence near the retail shelf;
adjusting operation parameters based on detected human presence; and
implementing collision avoidance measures.

18. The system of claim 1, wherein the robotic manipulator includes end-effector mounted cameras providing visual feedback for precise item placement.

19. The system of claim 1, further comprising a calibration routine configured to align coordinate systems between the sensor array and the robotic manipulator.

20. The system of claim 1, wherein the instructions further cause the system to execute a fronting and facing operation wherein items are placed at the front edge of the retail shelf with product labels facing forward according to planogram specifications.
